(19) United States
(12) Patent Application Publication
(10) Pub. No.: US 2020/0343512 A1
(43) Pub. Date: Oct. 29, 2020

(54) METHOD FOR PRODUCING A CONTACT PLATE FOR A BATTERY STACK, CONTACT PLATE FOR A BATTERY STACK AND BATTERY STACK

(71) Applicant: LION Smart GmbH, Garching (DE)

(72) Inventors: Tobias MAYER, München (DE); Sebastian STOLL, München (DE); Christian BEHLEN, München (DE); Devin ATUKALP, München (DE)

(73) Assignee: LION Smart GmbH, Garching (DE)

(21) Appl. No.: 16/762,042

(22) PCT Filed: Nov. 7, 2018
(86) PCT No.: PCT/EP2018/080499

§ 371 Date: May 6, 2020

(30) Foreign Application Priority Data
Nov. 7, 2017 (DE) 10 2017 219 768.4

(51) Int. Cl. H01M 2/20; H01M 2/10; B21D 22/02

(52) U.S. Cl. CPC H01M 2/202; B21D 22/02; H01M 2/1016

(57) ABSTRACT

A contact plate for a battery stack for electrically connecting battery cells of the battery stack in parallel and a method for producing the same, is provided. In the battery stack, the battery cells are arranged in an upper battery level and a lower battery level and the contact plate is arranged in the battery stack between the upper battery level and the lower battery level. A battery stack including at least one upper battery level, a lower battery level and a contact plate is further provided. A respective plurality of battery cells are arranged in the upper battery level and the lower battery level and the contact plate is arranged between the upper battery level and the lower battery level.

### CROSS REFERENCE TO RELATED APPLICATION

This application claims the benefit under 35. U.S.C. § 119(a) of German Application No. 10 2017 219 768.4 filed on Nov. 7, 2017, and is a national stage application filed under 35 U.S.C. § 371, of PCT/EP2018/080499, filed on Nov. 7, 2018, the contents of both are hereby incorporated by reference herein in their entirety.

### BACKGROUND OF THE DISCLOSURE

### 1. Field of the Disclosure

The invention relates to a method for producing a contact plate for a battery stack for electrically connecting battery cells of the battery stack in parallel, wherein, in the battery stack, the battery cells are arranged in an upper battery level and a lower battery level and the contact plate is arranged in the battery stack between the upper battery level and the lower battery level. The invention also relates to a contact plate for a battery stack for electrically connecting battery cells of the battery stack in parallel, wherein, in the battery stack, the battery cells are arranged in an upper battery level and a lower battery level and the contact plate can be arranged in the battery stack between the upper battery level and the lower battery level. The invention further relates to a battery stack comprising at least one upper battery level, a lower battery level and a contact plate, wherein a respective plurality of battery cells are arranged in the upper battery level and the lower battery level and the contact plate are arranged between the upper battery level and the lower battery level.

### 2. Description of the Related Art

Electrical energy storage systems are widely used in modern technology, for example in electric vehicles. Possible forms of such energy storage systems include lithium-ion batteries. In order to increase the performance of such batteries, it is known that several battery cells can be electrically connected in parallel on one battery level. To further increase the electrical performance of such batteries, two or more of these battery levels can be connected in series to form a battery stack. In particular, the individual battery levels can be arranged on top of each other and electrically connected.

For this electrical parallel connection of the individual battery cells of one battery level or even the battery cells of two successive battery levels, a contact plate is usually used according to the state of the art. The contact plate has several arrangement areas, which are intended for arranging the individual battery cells in the respective battery level or both battery levels. The individual battery cells in turn are electrically conductively connected to the contact plate, whereby the contact plate itself often consists of an electrically conductive body material. In this way an electrical parallel connection of the battery cells of one battery level can be realized.

According to the state of the art, it is also known that specially configured arrangement elements are provided for an electrically conductive connection between the individual battery cells and the contact plate. However, this has the disadvantage that prior to using the contact plate, it is necessary to mount the arrangement elements on the contact plate body in order to ensure a stable arrangement of the individual arrangement elements and, in particular, an electrically conductive connection of the arrangement elements with the plate body. Such an installation can incur time and, in particular, costs. Furthermore, the combined construction of a contact plate according to the state of the art from a plate body of a variety of arrangement elements can lead to an increased installation space requirement of the contact plate. Especially in the case of a battery stack with many battery levels and accordingly large number of necessary contact plates, this can lead to a high space requirement of the entire battery stack. This may prevent the battery stack from being particularly compact.

### SUMMARY

It is therefore the object of the present invention to at least partially eliminate the disadvantages described above. In particular, it is the object of the present invention to provide, in a cost-effective and simple manner, a method for the production of a contact plate, a contact plate as well as a battery stack, by means of which the production of such a contact plate can be simplified and improved overall, whereby in particular the installation space required for the contact plate can be reduced.

The above object is solved by a method for producing a contact plate for a battery stack with the features of independent claim 1, and a contact plate with the features of dependent claim 16. Furthermore, the object is solved by a battery stack with the features of the dependent claim 17. Further characteristics and details of the invention result from the dependent claims, the description and the drawings. Features and details described in connection with the method according to the invention are of course also valid in connection with the contact plate according to the invention as well as the battery stack according to the invention and vice versa, so that with regard to the disclosure of the individual aspects of the invention reference is or can always be made to each other.

According to a first aspect of the invention, the object is solved by a method for producing a contact plate for a battery stack for electrically connecting battery cells of the battery stack in parallel, wherein in the battery stack the battery cells are arranged in an upper battery level and a lower battery level and the contact plate is arranged in the battery stack between the upper battery level and the lower battery level. A method according to the invention is characterized by the following steps:
a) providing a flat plate body of a conductive plate material, wherein the plate body is arranged at least substantially in a plate plane,
b) defining arrangement areas for arranging one battery cell of the upper battery level and one battery cell of the lower battery level,
c) in each arrangement area, removal of plate material to form at least one arrangement space in each case,
d) in each arrangement area, forming at least one contact section from the plate material for electrically conductive contacting of a battery cell of the lower battery level, and
e) in each arrangement area, forming at least two holding sections from the plate material for an electrically conductive contact as well as form-fitting and/or force-locking and/or frictional-locking of a battery cell of the upper battery level.

A method according to the invention is intended for the production of a contact plate which can be used in a battery stack. With the aid of a contact plate produced by a method according to the invention, the battery cells of an upper battery level and a lower battery level of the battery stack can be electrically conductively connected. In addition, at least the battery cells of the upper battery level can be additionally held form-fitting and/or Force-locking and/or friction-locking by such a contact plate manufactured using a method according to the invention. In particular, a battery stack can also have a plurality of battery levels, wherein several contact plates produced according to a method according to the invention can be inserted, for which one of the battery levels can then represent an upper or lower battery level.

In a first step a) of a method according to the invention, a flat plate body of a conductive plate material is provided. Flat, in the sense of the invention, can be understood in particular to mean that the plate body is arranged at least substantially in one plate plane. In other words, the plate body may preferably be configured as a component, whose extension in a spatial direction, which in particular may later be the arrangement direction of the battery planes, is essentially determined by a thickness of the flat plate body. The provision of the plate body from a plate material which is particularly conductive also enables that the electrical parallel connection of the battery cells of the lower battery level and the upper battery level can be provided by the plate material of the plate body itself, so that no additional conduction elements need to be provided for this function.

In the next step b), arrangement areas are defined for arranging one battery cell each of the upper battery level and the lower battery level on the plate body. In other words, it may be particularly preferable that the arrangement area is defined in such a way that the battery cells of the upper battery level and the battery cells of the lower battery level can be arranged in pairs in alignment with each other in the later battery stack. In this way, it is particularly easy to provide that an arrangement of the battery cells is the same in each battery level, so that a modular structure of the entire battery stack can be provided in a simplified way. In summary, after step b) of a method according to the invention has been performed, it is determined at which positions of the plate body the battery cells of the lower battery level and the upper battery level are to be arranged later for an electrical contact or parallel connection.

The following step c) includes the formation of arrangement space in each arrangement area. An arrangement space can be understood in particular to mean that a continuous opening is created in the plate body which is free of plate material by the removal of plate material. In this way, it can be prepared that in the following steps d) and e) special elements of the contact plate are produced, in particular contact sections and holding sections which are explicitly intended for contacting and/or holding the battery cells in the battery levels. A specially defined and determinable contacting or holding of the battery cells can be provided in this way.

The next step d) comprises forming at least one contact section of plate material in each arrangement area, the contact section being intended for contacting a battery cell of the lower battery level. This contacting is in particular an electrically conductive contacting, so that each contact section provides a defined electrical contacting for a specific battery cell. The contact section can also be configured to match the battery cells used, for example to match the shape of a positive pole. When assembling the battery stack, the contact between the respective contact section and one pole of the corresponding battery cell can be further improved by a material connection, for example soldering or welding, preferably laser welding.

In the last step e) of a method according to the invention, at least two holding sections are now formed in each arrangement area for electrically conductive contacting of a battery cell of the upper battery level. In addition, in step e) of a method according to the invention, the holding sections are shaped in such a way that, in addition to the electrically conductive contacting, they are also formed to provide a form-fitting and/or force-locking and/or friction-locking holding of the respective battery cell of the upper battery level. A battery cell can be held securely by just two such holding sections. In further preferred embodiments, several such holding sections, for example three or more holding sections, may also be provided, which may in particular also be distributed along a circumference of the battery cell to be arranged in each arrangement area. When assembling the battery stack, a further improvement of the electrical contact and in particular of the holding is also possible with the holding sections by means of a material connection, for example soldering or welding, preferably laser welding, of the respective holding sections to one pole of the corresponding battery cell.

In summary, a contact plate based on a flat plate body can thus be produced by a method according to the invention, wherein both the contact sections for electrical contacting of a battery cell of the lower battery level and the holding sections for electrical contacting and for holding a battery cell of the upper battery level are formed from plate material of the plate body. In particular, this form is not only a mental provision of the contact sections or the holding sections, but an actual provision, so that after steps d) and e) of a method according to the invention, the contact sections and holding sections are actually available in an objective manner. By the production the entire contact plate and its contact sections and holding sections from the flat plate body, the use of additional holding elements can be dispensed with. A method according to the invention is thus configured to produce a contact plate in a fast and in particular also simple and inexpensive manner.

Furthermore, a method according to the invention may provide that the removal of plate materials in step c) is performed by punching and/or cutting and/or welding, in particular laser cutting. By punching and/or cutting and/or welding, a particularly simple and at the same time precise removal of plate material can be performed. Laser cutting can be used as a particularly preferred method, which can further increase the precision of the removal of plate material. A particularly safe and in particular exact and precise execution of step c) of a method according to the invention can be provided in this way.

In addition, a method according to the invention may provide that when removing plate materials in step c) the individual arrangement areas remain electrically conductively connected by connecting sections of plate material, whereby in particular plate material between the arrangement areas is also removed. By leaving plate material between the arrangement areas, it can be ensured in particular that the individual arrangement areas, especially the contact sections and the holding sections in the individual arrangement areas, remain electrically connected to each other. An electrical parallel connection of all battery cells, which are later arranged in the respective arrangement areas in the battery stack, can be ensured in this way. In addition, by further removing plate material between the arrangement areas, the weight of a contact plate manufactured by a method according to the invention can also be reduced without affecting the functionality of the electrical parallel connection. Especially for battery stacks that have a high number of battery levels and therefore many required contact plates, the total weight of the battery stack can be reduced in this way.

According to a particularly preferred embodiment of a method according to the invention, it may further be provided that steps d) and/or e) are performed at least partially simultaneously with step c), in particular that the contact section and/or the at least two holding sections are at least partially formed by removing plate material. In this way, an acceleration of a production of the contact plate according to a method according to the invention can be provided. In particular, the forming of the contact sections or the holding sections performed in steps d) and e) may also, at least in part, involve the removal of plate material. In this way, for example, an external shape of the contact sections or the holding sections can be provided at least partially already by removing plate material. An increase in the manufacturing speed of a contact plate can thus be provided in this form of a method according to the invention.

Furthermore, in a method according to the invention, it may be provided that the forming of the at least one contact section in step d) comprises a deformation of the contact section in the direction of a lower side of the plate body. Forming in the sense of the invention can in particular also be a bending out of the contact section in the direction of the lower side of the plate body. In this way it can be provided, for example, that the battery cells of the lower battery level do not have to have direct contact with the plate body in its plate plane. The contact sections alone are then intended to establish the electrically conductive contact between the contact plate and the battery cells of the lower battery level. A specially definable and adjustable electrical contact between the battery cells of the lower battery level and the contact plate can be provided in this way. In addition, the fact that after forming the contact sections protrude towards the lower side of the plate body means that a certain spring effect of the contact sections can be provided. Slight inaccuracies in the arrangement of the contact plate or the battery cells of the lower battery level can be compensated in this way.

Correspondingly, according to an alternative or additional embodiment of a method according to the invention, it may be preferably provided that the forming of the at least two holding sections in step e) comprises a deformation of the at least two holding sections in the direction of the upper side of the plate body. Again, this forming of the holding sections may involve bending the holding sections from the plate plane in the direction of the upper side of the plate body. The holding sections can also be configured with a certain spring effect in this way, which provides the advantages already described above of at least a rudimentary length compensation. Direct contact between the battery cells of the upper side of the battery level and the plate body in the plate plane can also be avoided by means of holding sections that are shaped towards the top of the plate body. This electrically conductive contact can also be specially defined and planned in this way.

In addition, a method according to the invention can also be configured in such a way that when the at least two holding sections are formed in step e), the holding sections are formed with a spacer section, the spacer section preferably being aligned transversely or at least substantially transversely to the plate plane. In particular, such a spacer section enables a defined distance to be provided between a lower end of the battery cell of the upper battery level and the plate body of the contact plate. This defined distance enables, for example, an insulation element to be arranged between the plate body of the contact plate and the battery cells of the upper battery level, for example for thermal and/or electrical insulation. Such an insulating element can be made of a plastic material or a ceramic material, for example. In the sense of the invention, transverse to the plate plane can in particular be perpendicular to the latter, whereby, in addition to providing the defined distance, particularly good transmission of force between the battery cells and the contact plate, in particular with regard to pressure and/or tensile forces, can be provided. In this case, the individual battery cell can also be used to transmit such forces in the battery stack, so that an overall increase in overall stability of the battery stack can be achieved.

Furthermore, in a method according to the invention it may be provided that prior to step c) in each arrangement area, plate material is deep-drawn in the direction of an upper side of the plate body, in particular deep-drawn in the form of a truncated cone. In this way, an enlargement of an area of the plate body can be achieved locally. The possibilities of forming a holding section can be increased in this way, since a larger area of plate material is available, especially for forming the holding sections. In particular, there is no absolute limitation of the size or configuration of the holding sections by the size of the individual arrangement areas or the individual respective arrangement spaces. A particularly large number of different shapes of a contact plate can thus be provided in this form by the use of a method according to the invention.

Particularly preferred in a method according to the invention can be further developed in such a way that in step e) the at least two holding sections are at least partially formed in the deep-drawn area. In this particularly preferred embodiment of a method according to the invention, the advantages described above can be provided especially for the at least two holding sections. Particularly large holding sections, which may also be particularly well configured to hold the battery cells of the upper battery level, can be provided in this way.

A method according to the invention may also be further developed to the effect that in step c) plate material with a loss of flow resulting from deep drawing is at least partially, preferably completely, removed. Such a flow loss in the plate material can, for example, impair the structural stability of the plate material. Work hardening, which can also be a hindrance in certain embodiments of contact plates manufactured by a method according to the invention, can also occur as a loss of flow in the plate material. The fact that in step c) precisely this plate material with the flow loss which arises during deep drawing at least partially, preferably completely removed, can be safely avoided that the disadvantages which would occur with such a plate material with a resulting flow are reflected in the contact plate produced by a method according to the invention.

Furthermore, a method according to the invention may preferably be configured in such a way that the forming of the contact section in step d) comprises producing a contact securing section as part of the contact section and/or the forming of the at least two holding sections in step e) comprises producing a holding securing section as part of the at least two holding sections. Such fuse sections can preferably be shaped as areas of the contact section or holding sections which have a particularly small cross-section, for example smaller than 5 mm², preferably smaller than 1 mm². In this way, protection against an overload inside the battery stack can be provided by a contact plate manufactured by a method according to the invention. If, for example, there is too much current that has to flow through the contact plate when the individual battery cells are electrically connected in parallel, the contact securing section and/or the holding securing section will cause the electrical parallel connection to separate, for example by melting. In particular, both the contact section and the holding sections each have at least one holding section, so that a double and in particular redundant holding of a battery stack can be provided when using a contact plate manufactured by a method according to the invention against in particular an overload.

In accordance with a further development of a method according to the invention, it may also be provided that the contact securing section and/or the holding securing section are generated in the plate plane and/or in a mechanically load-free or at least substantially load-free area of the plate body. As already described above, the contact securing section or the holding securing section can each preferably be configured as an area with a particularly small cross-section. By providing the contact securing section and/or the holding securing section within the plate plane and/or preferably in a mechanically load-free or at least substantially load-free area of the plate body, it can be ensured that a deformation of the respective securing section does not impair, or at least only insignificantly impairs, an overall mechanical stability of a contact plate manufactured by a method according to the invention. In particular, the securing sections can be configured with a particularly small cross-section in this way, since the areas in which the contact securing section and/or the holding securing section are located need not contribute any mechanical stability whatsoever to the overall stability of the contact plate produced.

Furthermore, a method according to the invention can be further developed in such a way that the contact securing section and/or the holding securing section are produced by punching and/or cutting and/or welding, in particular laser cutting, whereby preferably the contact securing section and the holding securing section are produced simultaneously. In particular, the contact securing section and/or the holding securing section can be produced by removing plate material, whereby, as already described above, punching and/or cutting and/or welding are preferred methods for performing such removal, and by simultaneously inserting a contact securing portion and a holding securing portion, a speed in performing a method according to the invention can also be increased.

A method according to the invention may also be configured in such a way that a connector section for connecting the contact plate to a control and/or monitoring unit is formed on the plate body. In particular, molding may, in the sense of the invention, include forming the connector section of plate material of the plate body. In this way, provision can be made for a control and/or monitoring interface for subsequent connection of the battery stack to such a control and/or monitoring unit. Additional interface elements when building a battery stack can be avoided or at least reduced in size in this way.

In accordance with a further preferred form of configuration of a method according to the invention, it can also be provided that a forming tool is repeatedly used at least for a partial performance of steps c) and/or d) and/or e), wherein the forming tool is configured for the simultaneous at least partial performance of steps c) and/or d) and/or e) for 15 or fewer arrangement areas, in particular 10 or fewer arrangement areas, preferably between 5 and 2 arrangement areas. In other words, for a certain, in particular small number of arrangement areas, such a mold can be configured in such a way that the arrangement space and/or the contact section and/or the holding section can be formed therein. A contact plate, which in particular has significantly more arrangement areas than the forming tool can handle, can thus be produced in particular by repeated use of the forming tool. In particular, a number of the arrangement areas that a contact plate has can also be modularly adjusted by the number of repetitions of the use of the forming tool. A particularly simple provision of a large number of contact plates with a different number of arrangement areas can be provided in this way in a particularly simple and particularly flexible manner.

According to a second aspect of the invention, the object is solved by a contact plate for a battery stack for electrical parallel connection of battery cells of the battery stack, wherein in the battery stack the battery cells are arranged in an upper battery level and a lower battery level and the contact plate is arranged between the upper battery level and the lower battery level in the battery stack. A contact plate according to the invention is characterized in that the contact plate is produced by a method according to the first aspect of the invention. All advantages which have been described in detail with respect to a method according to the first aspect of the invention can thus also be provided by a contact plate according to the second aspect of the invention, which has been produced by a method according to the first aspect of the invention.

According to a third aspect of the invention, the object is solved by a battery stack with at least an upper battery level, a lower battery level and a contact plate, wherein a plurality of battery cells are arranged in each of the upper battery level and the lower battery level and the contact plate is arranged between the upper battery level and the lower battery level. A battery stack according to the invention is characterized in that the contact plate is formed according to the second aspect of the invention. A contact plate according to the second aspect of the invention is formed by a method according to the first aspect of the invention. All the advantages which have been described in detail with respect to a contact plate according to the second aspect of the invention and in particular with respect to a method according to the first aspect of the invention can thus also be provided by a battery stack according to the third aspect of the invention which has such a contact plate according to the second aspect of the invention.

### BRIEF DESCRIPTION OF THE DRAWINGS

Further advantages, features and details of the invention are given in the following description, in which, with reference to the drawings, embodiments of the invention are described in detail. The features mentioned in the claims and in the description may be individually or in any combination substantially inventive. The preceding explanation of the embodiments describes the present invention exclusively in the context of examples. Of course, individual features of the embodiments can be freely combined with each other, if technically reasonable, without leaving the scope of the present invention. Elements with the same function and mode of operation are marked with the same reference signs in the figures. They are schematically shown:

FIG. 1 shows a method according to the invention.

FIG. 2 shows a contact plate according to the invention during its production.

FIG. 3 shows the contact plate of FIG. 2 according to the invention during a later phase of its production.

FIG. 4 shows a first detailed picture of the contact plate shown in FIG. 2.

FIG. 4 shows a first detailed picture of the contact plate shown in FIG. 3.

FIG. 6 shows a further embodiment of a contact plate according to the invention.

FIG. 7 shows the contact plate shown in FIG. 6 with an insulation element.

FIG. 8 shows a battery stack with a contact plate shown in FIG. 6.

### DETAILED DESCRIPTION

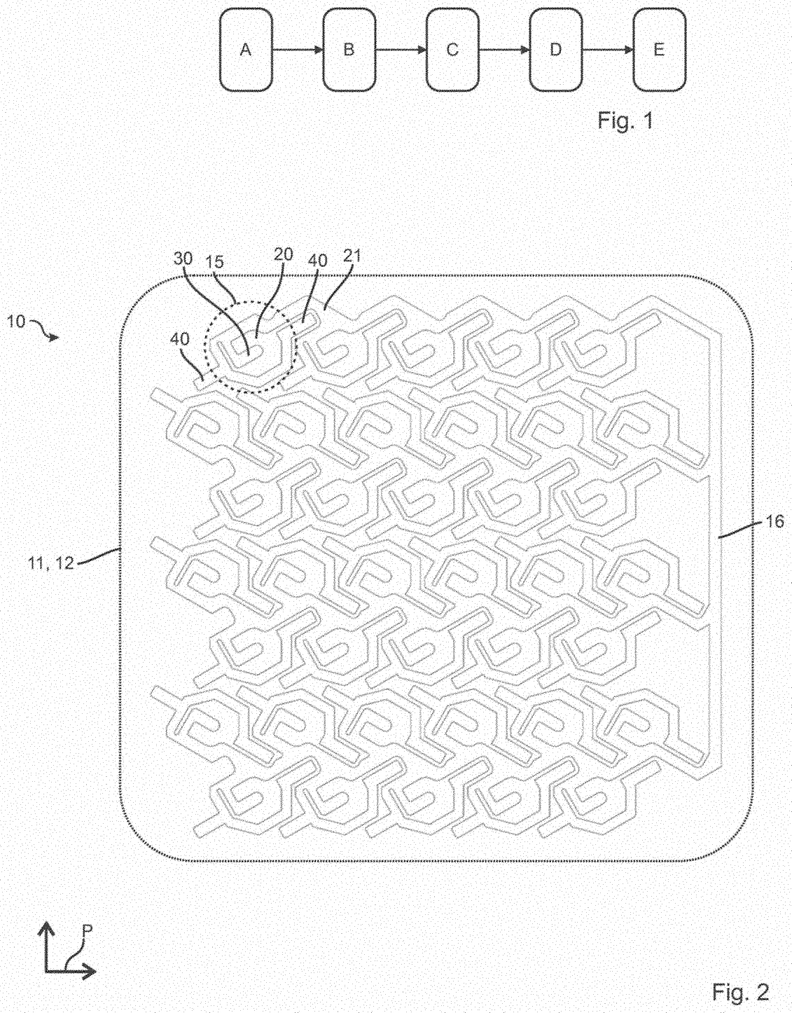

In FIG. 1, the steps of a method according to the invention are shown schematically. The individual steps a) to e) are marked with capital letters A to E. FIGS. 2 to 8 are described in the following, whereby reference is made to FIG. 1 when referring to individual steps of the method according to the invention.

FIG. 2 shows a contact plate 10, during an intermediate step of its production according to a method according to the invention. A plate body 11 made of an electrically conductive plate material 12 was provided in a first step a). In the next step b), a large number of arrangement areas 15 have already been defined on the plate body 11, of which in FIG. 2 only one of the arrangement areas 15 is marked with a reference sign to increase clarity. By removing plate material 12 in the next step c), preferably by a method of punching and/or cutting and/or welding, in particular laser cutting, an arrangement space 20 was formed in each of the arrangement areas 15. Furthermore, parts of steps d) and e) have already been performed, also simultaneously with step c) of a method according to the invention, in order to form in particular the contact sections 30 and the holding sections 40, at least with respect to their outer circumferential shape in the plate plane P, by removing plate material 12. It is clearly visible that the individual arrangement areas 15 are similar, whereby in particular, for example, in the embodiments of the contact plate 10, eleven arrangement areas 15 are arranged in a group. In particular, for at least partial performance of steps c) and/or d) and/or e), a forming tool can be used repeatedly, the forming tool being configured for simultaneous at least partial performance of steps c) and/or d) and/or e), for example these eleven arrangement areas 15. A modular adjustment of a total number of contact areas 15 can thus be individually enabled for each production series of a contact plate 10. Connecting sections 21 remain between the individual arrangement areas 15, which ensures electrical parallel connection when the manufactured contact plate 10 is later used in a battery stack 1 (not shown). In addition, when removing the plate material 12, a connector section 16 was formed, which may later be used for connecting a control and/or monitoring unit for controlled operation of battery stack 1.

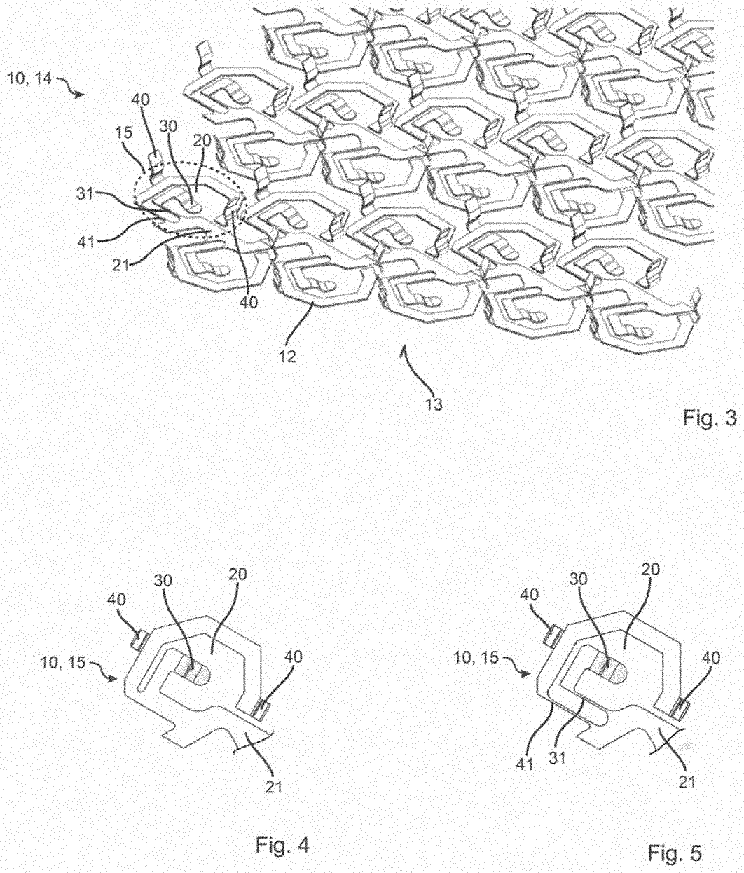

In the next FIG. 3 the contact plate 10 shown in FIG. 2 is shown again, now in a later stage of production. When step d) was performed, the contact sections 30 were shaped, in particular bent out, in the direction of a lower side 13 of the contact plate 10. The same was done for the holding sections 40, which were formed in step e) in the direction of the upper side 14 of the contact plate 10, in particular they were also bent out. In this illustration in FIG. 3, it is in particular clearly visible that the at least two holding sections 40 are opposite each other in the arrangement area 15, as a result of which a form-fitting and/or force-locking and/or friction-locking of a battery cell 3 (not shown in the illustration) can be provided between the holding sections 40. In addition, a contact securing section 31 is also formed on contact section 30 and a holding securing section 41 on holding section 40 in this configuration. This is particularly evident in FIGS. 4 and 5, where FIG. 4 shows a detailed view of an arrangement area 15 of the contact plate 10 from FIG. 2 and FIG. 5 shows a detailed view of an arrangement area 15 of the contact plate 10 from FIG. 3. In particular, it is clearly visible that the contact securing section 31 and the holding securing section 41 are formed by areas of the contact section 30 and holding section 40 respectively, which have a particularly small cross-section. In the event of an overload it can be provided in this way that the contact plate 10 melts through at these points and thus the electrical parallel connection of the arranged battery cells 3 (not shown) is interrupted. It is also visible that the securing sections 31, 41 are generated in the plate plane P, which means that they can be generated preferably also in a mechanically load-free or at least substantially load-free area of the plate body 11. The removal of the plate material 12 (not shown in the illustration) to create the contact securing section 31 as well as the holding securing section 41 can be performed, in particular, just like the removal of the plate material 12 to create the arrangement spaces 20, preferably by punching, cutting and/or welding, preferably laser cutting. All in all, a contact plate 10 can be produced by a method according to the invention, the contact sections 30 and holding sections 40 of which are formed from the flat plate body 11, whereby the addition of additional holding elements or contact elements can be avoided. A simplification of the production of a contact plate 10, a reduction of production costs and manufacturing effort can be provided in this way.

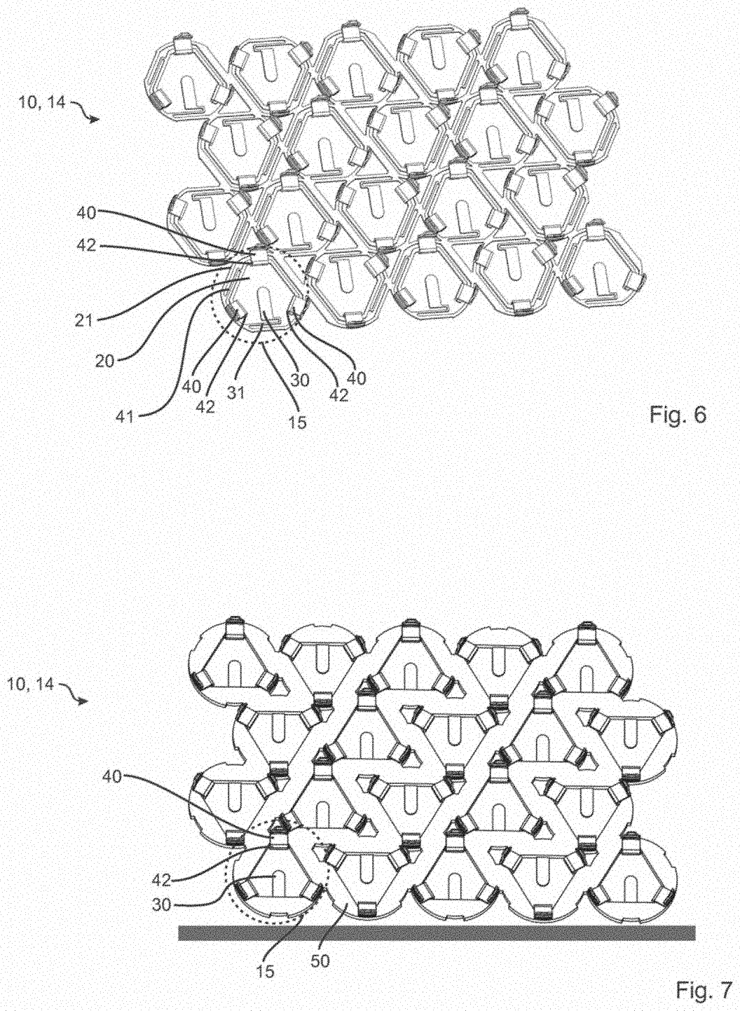

FIG. 6 shows a further embodiment of a contact plate 10 according to the invention, which in turn has been manufactured by a method according to the invention, as shown in FIG. 1. Again the upper side 14 of contact plate 10 is visible. This contact plate 10 also has a number of arrangement areas 15, of which one of the arrangement areas 15 is shown in FIG. 6. In this arrangement area 15 there is again a contact section 30 and a contact securing section 31, which projects into an arrangement space 20. In this embodiment of a contact plate 10 according to the invention, three holding sections 40 are provided in each arrangement area 15, which are connected to the remaining contact plate 10 via a common holding securing section 41. Via connecting sections 21, the individual arrangement areas 15, in particular those in contact sections 30 and holding sections 40, are in turn electrically conductively connected to one another in order to be able to provide electrical parallel connection of the battery cells 3 (not shown) arranged on them. The embodiment of a contact plate 10 according to the invention has special features. Thus, the holding sections 40 have a larger surface area than would be possible by simply bending plate material 12 (not shown) out of plate plane P (not shown). In order to provide this, it may be intended, in accordance with a method according to the invention, to perform a deep drawing in each arrangement area 15 before removing plate material 12 in step c). Preferably, in the following, the holding sections 40 can be formed at least partially in this deep-drawn area, in particular in such a way that areas of the plate material 12 with a loss of flow resulting from deep drawing are at least partially, particularly preferably completely, not used for forming the holding sections 40. In this way, the produced contact plate 10 can be influenced as little as possible by the deep drawing method. Furthermore, the contact holding sections 40 shown are configured with spacer sections 42. These spacer sections 42 can preferably be arranged transverse to the plate plane P (not shown), resulting in a defined distance between the holding sections 40 and the rest of the contact plate 10.

This enables in particular, as shown in FIG. 7, to arrange an insulating element 50 on the contact plate 10, whereby in particular it is clearly visible that the spacer section 42 allows the insulating element 50 to be gripped by the holding sections 40. A particularly secure holding of the insulation element 50 can be provided in this way.

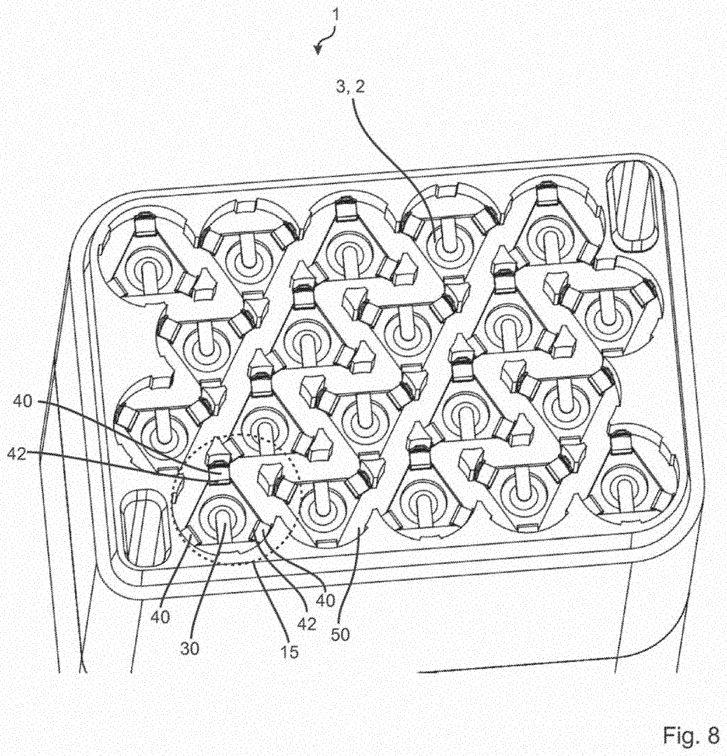

FIG. 8 now shows a battery stack 1 according to the invention, in that a contact plate 10 shown in FIG. 7, for example, is installed with an insulation element 50. The contact sections 30 of the contact plate 10 are electrically conductively connected to the battery cells 3 of the lower battery level 2, for example welded on, preferably laser-welded. The battery cells 3 of the upper battery level are not shown, but are placed on the holding sections 40 of the contact plate 10 and are held securely by these in a form-fitting, force-fitting and/or friction-fitting manner and at the same time are contacted in an electrically conductive manner. A particularly simple, modular structure of the entire battery stack 1 can be provided in this way.

### REFERENCE SIGNS

1 battery stack
2 lower battery level
3 battery cell
10 contact plate
11 plate body
12 plate material
13 lower side
14 upper side
15 arrangement area
16 connector section
20 arrangement space
21 connection section
30 contact section
31 contact securing section
40 holding section
41 holding securing section
42 spacer section
50 insulation element
P plate plane

What is claimed is:

1. A method for producing a contact plate for a battery stack for electrically connecting battery cells of the battery stack in parallel, wherein, in the battery stack, the battery cells are arranged in an upper battery level and a lower battery level and the contact plate is arranged in the battery stack between the upper battery level and the lower battery level, and wherein the method further comprises the following steps:
a) providing a flat plate body of a conductive plate material, wherein the plate body is arranged at least substantially in a plate plane,
b) defining arrangement areas for arranging one battery cell of the upper battery level and one battery cell of the lower battery level,
c) removal of plate material in each arrangement area to form at least one arrangement space in each case,
d) forming at least one contact section from the plate material in each arrangement area for electrically conductive contacting of a battery cell of the lower battery level, and
e) forming at least two holding sections from the plate material in each arrangement area for at least electrically conductive contacting and for form-fitting or force-locking or friction-locking of a battery cell of the upper battery level.

2. The method according to claim 1,
wherein the removal of plate material in step c) is effected by punching or cutting or welding.

3. The method according to claim 1,
wherein when removing plate material in step c), the individual arrangement areas remain electrically conductively connected by connecting sections of plate material.

4. The method according to claim 1,
wherein at least steps d) or e) are performed at least partially simultaneously with step c).

5. The method according to claim 1,
wherein the forming of the at least one contact section in step d) comprises a deformation of the contact section in the direction of a lower side of the plate body.

6. The method according to claim 1,
wherein the forming of the at least two holding sections in step e) involves a deformation of the at least two holding sections in the direction of an upper side.

7. The method according to claim 1,
wherein during the forming of the at least two holding sections in step e), the holding sections are formed with a spacer section, the spacer section preferably being oriented transversely or at least substantially transversely to the plate plane.

8. The method according to claim 1,
wherein before step c), plate material is deep-drawn in each arrangement area in the direction of an upper side of the plate body.

9. The method according to claim 8,
wherein in step e) the at least two holding sections are at least partially formed in the deep-drawn area.

10. The method according to claim 8,
wherein in step c) plate material with a loss of flow resulting from deep-drawing is at least partially removed.

11. The method according to claim 1,
wherein the forming of the contact section in step d) comprises at least producing a contact securing section as part of the contact section or the forming of the at least two holding sections in step e) comprises producing a holding securing section as part of the at least two holding sections.

12. The method according to claim 11,
wherein at least the contact securing section or the holding securing section are generated at least in the plate plane or in a mechanically load-free or at least substantially load-free region of the plate body.

13. The method according to claim 11,
wherein at least the contact securing section or the holding securing section are produced by at least punching or cutting or welding.

14. The method according to claim 1,
wherein a connector section for at least connecting the contact plate to a control or monitoring unit is molded onto the plate body.

15. The method according to claim 1,
wherein a forming tool is repeatedly used at least for a partial performance of at least steps c) or d) or e), wherein the forming tool is configured for simultaneous at least partial performance of at least steps c) or d) or e) for 15 or fewer arrangement areas.

16. A contact plate for a battery stack for electrically connecting battery cells of the battery stack in parallel, wherein, in the battery stack, the battery cells are arranged in an upper battery level and a lower battery level and the contact plate is arranged in the battery stack between the upper battery level and the lower battery level, wherein the contact plate is produced by a method for producing a contact plate for a battery stack for electrically connecting battery cells of the battery stack in parallel, wherein, in the battery stack, the battery cells are arranged in an upper battery level and a lower battery level and the contact plate is arranged in the battery stack between the upper battery level and the lower battery level, wherein the method further comprises the following steps:
a) providing a flat plate body of a conductive plate material, wherein the plate body is arranged at least substantially in a plate plane,
b) defining arrangement areas for arranging one battery cell of the upper battery level and one battery cell of the lower battery level,
c) in each arrangement area, removal of plate material to form at least one arrangement space in each case,
d) in each arrangement area, forming at least one contact section from the plate material for electrically conductive contacting of a battery cell of the lower battery level, and
e) in each arrangement area, forming at least two holding sections from the plate material for at least electrically conductive contacting and for form-fitting or force-locking or friction-locking of a battery cell of the upper battery level.

17. A battery stack comprising at least one upper battery level, a lower battery level and a contact plate, wherein a respective plurality of battery cells are arranged in the upper battery level and the lower battery level and the contact plate is arranged between the upper battery level and the lower battery level, wherein the contact plate is formed according to a contact plate for a battery stack for electrically connecting battery cells of the battery stack in parallel, wherein, in the battery stack, the battery cells are arranged in an upper battery level and a lower battery level and the contact plate is arranged in the battery stack between the upper battery level and the lower battery level, wherein the contact plate is produced by a method for producing a contact plate for a battery stack for electrically connecting battery cells of the battery stack in parallel, wherein, in the battery stack, the battery cells are arranged in an upper battery level and a lower battery level and the contact plate is arranged in the battery stack between the upper battery level and the lower battery level, wherein the method further comprises the following steps:
a) providing a flat plate body of a conductive plate material, wherein the plate body is arranged at least substantially in a plate plane,
b) defining arrangement areas for arranging one battery cell of the upper battery level and one battery cell of the lower battery level,
c) in each arrangement area, removal of plate material to form at least one arrangement space in each case,
d) in each arrangement area, forming at least one contact section from the plate material for electrically conductive contacting of a battery cell of the lower battery level, and
e) in each arrangement area, forming at least two holding sections from the plate material for at least electrically conductive contacting and for form-fitting or force-locking or friction-locking of a battery cell of the upper battery level.

18. The method according to claim 8, wherein in step c) plate material with a loss of flow resulting from deep-drawing is completely removed.
